(19) United States
(12) Patent Application Publication
(10) Pub. No.: US 2006/0036599 A1
(43) Pub. Date: Feb. 16, 2006

(54) Apparatus, system, and method for identifying the content representation value of a set of terms

(76) Inventors: Howard Justin Glaser, San Jose, CA (US); Vivian Wai-Man Tsang, Scarborough (CA)

Correspondence Address: KUNZLER & ASSOCIATES, 8 EAST BROADWAY, SUITE 600, SALT LAKE CITY, UT, 84111, US

(21) Appl. No.: 10/914,484

(22) Filed: Aug. 9, 2004

(51) Int. Cl. G06F 7/00

(52) U.S. Cl. 707/7

(57) ABSTRACT

An apparatus, system, and method are provided for identifying the content representation value of a set of terms. The apparatus includes an input module, a rules module, a sorting module, and an output module. The input module parses a document to identify a set of terms used in the document. The rules module determines a representation score by applying a set of relevancy rules to each term. The representation score indicates how well a term represents the content of the document. The sorting module sorts the set of terms based on the representation score for each term. The output module provides the sorted set of terms. The representation scores may be used to facilitate creating, editing, or revising the document.

### BACKGROUND OF THE INVENTION

1. Field of the Invention

The invention relates to document searching. Specifically, the invention relates to apparatus and methods for identifying the content representation value of a set of terms within a particular document.

2. Description of the Related Art

Thanks to the increasing popularity of electronic publishing, there is a large amount of information available on substantially any topic on the Internet. For the information to be useful, the information needs to efficiently found and retrieved. One conventional way of locating information uses a search engine to locate documents that contain one or more search terms provided by a user. The search engine provides the user with a list of documents ordered by their relevancy to the search terms.

The list of documents returned by the search engine can comprise web pages, published documents, files, or the like. If the document is a web page, the document can include attributes, tags, text, sections, panels, and other components that comprise the web page. A published document may be a word processing document, a markup language document, a document in Portable Document Format (PDF), or the like.

Search engines rank a plurality of documents known to the search engine in order of relevancy to the search terms. Search engines rank a document using one or more relevancy rules. For example, a relevancy rule can test to see if a search term is present in the title of the document. Other common relevancy rules may include counting the number of times a search term is used in the document, the location of the search term in the document, whether or not the search term is in the abstract of the document, and the proximity of one search term to other search terms. The search engine sums the weighted results from each of these rules to determine an overall relevancy score for the document. The search engine orders the list of documents by each document's relevancy score.

The ordered list of documents returned by the search engine may or may not be useful to the user. Often, documents that effectively meet the needs of the user are not identified by the search engine, or are not highly ranked by the search engine. One reason for a low ranking can be that the document is written without a knowledge or clear understanding of the relevancy rules used by the search engine to rank the document. For example, a document can very effectively meet the needs of a user, but if one of the search terms is not in the title, the document will receive a lower ranking than other, less useful documents that do include the search term in the title. Writing documents with relevancy rules in mind can minimize the occurrence of the problem described above. Doing so, however, can interfere with the creative or technical objective in initially drafting the document. Preferably, the author should be unconcerned with relevancy rules and or search engine ranking while drafting the document.

FIG. 1 illustrates a conventional system 100 for publishing and retrieving electronic documents. An author creates a document 102 and provides the document 102 to a web server 104 or other repository. The author can make the document 102 available to a set of private or public users. A search engine 106 is made aware of the new document 102 either by a manual registration of the document 102 or by an automatic discovery of the document 102 using a web crawler or similar technology.

Once the search engine 106 discovers the document 102, an indexer 108 indexes the document 102 and stores information about the document 102 in a database 1110. The search engine 106 is now able to include the document 102 in response to search requests.

A user submits one or more search terms 112 to the search engine 106. A searcher 114 compares the search terms 112 to information stored about indexed documents 102. The searcher 114 uses indexed document information in the database 110 to build a list of documents 102 that are most relevant to the search terms 112. The search engine 106 returns a ranked document list 116 to the user with the most relevant document 102 at the top of the list 116. The search engine 106 determines which documents 102 are relevant to the search terms 112 using one or more of the relevancy rules described above.

Unfortunately, the search engine 106 might not include the document 102 that a user would determine to be most relevant in the ranked document list 116. Alternatively, the document 102 might be ranked very low in the ranked document list 116. The document 102 that the user would determine to be most relevant might be written in a manner that prevents the document 102 from being highly ranked by the search engine 106. The author of such a document 102 may not know how to write documents 102 that the search engine 106 will rank highly for the search terms 112. As a result, the author can unintentionally prevent the user from locating the document 102 due to a format of the document content that results in a low ranking from the search engine 106.

The author can attempt to optimize the document 102 for a particular search term 112 using a trial and error process of editing the document 102 and then re-submitting the document 102 to a search engine 106, conducting a search using the search terms 112 and hope for a higher ranking. If the search engine 106 provides a higher ranking for the document 102, the edits were successful. If the ranking remains the same or decreases, the edits were not successful. A trial and error process may be lengthy in large document management and publishing facilities, making a trial and error approach impractical.

A more efficient way to optimize the document 102 for a particular search term is to request a description of the search engine relevancy rules from the operator of a search engine 106. However, search engine operators typically do not readily provide the rules. Even if the author acquires the relevancy rules for a search engine 106, remembering the rules while drafting the document 102 is difficult and can interfere with the drafting process. Authors typically find it difficult to remember relevancy rules while writing. Similarly, attempting to manually compute a relevancy ranking for the document 102 during the drafting process is not practical.

From the foregoing discussion, it should be apparent that a need exists for an apparatus and method that identify the content representation value of a set of terms found in a document 102. Beneficially, such an apparatus and method would assist document authors in optimizing search engine relevancy scores for specific terms. Optimized documents 102 will minimize the amount of time a user spends searching for relevant documents with a search engine 106.

### SUMMARY OF THE INVENTION

The various embodiments of the present invention have been developed in response to the present state of the art, and in particular, in response to the problems and needs in the art that have not yet been met for identifying the content representation value of a set of terms. Accordingly, the various embodiments have been developed to provide an apparatus and method for identifying the content representation value of a set of terms that overcomes many or all of the above-discussed shortcomings in the art.

An apparatus according to one embodiment of the present invention includes an input module, configured to parse a document and identify a set of terms used in the document; a rules module, configured to determine a representation score by applying a set of relevancy rules to each term; a sorting module, configured to sort the set of terms based on the representation score for each term; and an output module, configured to provide the sorted set of terms.

The input module may be further configured to eliminate irrelevant terms from the set of terms to increase efficiency. The rules module may be further configured to modify the set of relevancy rules to be used in determining the representation score for each term. The ability to modify the set of relevancy rules enables new rules to be added to the rules module in the future.

Preferably, the apparatus is configured to provide interactive feedback while editing an electronic version of a document. The output module may be configured to mark the representation score for each term in the electronic version of the document, and the rules module may be configured to interactively determine the representation score for each term as the electronic version of document is being edited.

The sorting module may be further configured to suggest changes to the document that will improve the representation score of a selected term. The output module may be further configured to provide the representation score for each term, and a representation sub-score for each relevancy rule for each term.

Optionally, the apparatus may be configured to determine a synonym representation score by applying the set of relevancy rules to each of a set of synonyms for a selected term. The set of synonyms are sorted based on the synonym representation score for each synonym and the output module provides the sorted set of synonyms.

An apparatus according to another embodiment of the present invention includes a section module, an input module, a rules module, an aggregation module, a sorting module, and an output module. The section module identifies sections of a document. The input module parses a document and identifies a set of terms used in the document. The rules module determines a set of section representation scores by applying a set of relevancy rules to each term. The aggregation module weights the set of section representation scores for each term to determine an overall representation score. The sorting module sorts the set of terms based on the overall representation score for each term. The output module provides the sorted set of terms.

A method according to one embodiment of the present invention includes parsing a document to identify a set of terms used in the document and then determining a representation score by applying a set of relevancy rules to each term. Next, a sorting module sorts the set of terms based on the representation score for each term and provides the sorted set of terms.

The present invention also includes embodiments arranged as machine-°readable instructions that comprise substantially the same functionality as the components and steps described above in relation to the apparatus. Embodiments of the present invention provide a generic content representation value identification solution that ranks each of a set of terms by the ability of the term to represent the content of a document. The features and advantages of different embodiments will become more fully apparent from the following description and appended claims, or may be learned by the practice of embodiments of the invention as set forth hereinafter.

### BRIEF DESCRIPTION OF THE DRAWINGS

In order that the advantages of the different embodiments of the invention will be readily understood, a more particular description of the embodiments briefly described above will be rendered by reference to specific embodiments that are illustrated in the appended drawings. Understanding that these drawings depict only typical embodiments of the invention and are not therefore to be considered to be limiting of its scope, the embodiments will be described and explained with additional specificity and detail through the use of the accompanying drawings, in which:

FIG. 1 is a schematic block diagram of a conventional system for publishing and retrieving documents;

FIG. 2 is a schematic block diagram of one embodiment of an apparatus for identifying the content representation value of a set of terms;

FIG. 3 is a schematic block diagram of one embodiment of an apparatus for identifying the content representation value of a set of terms;

FIG. 4 is a chart illustrating an example set of ranked terms;

FIG. 5A is a flow chart diagram illustrating one embodiment of a method for identifying the content representation value of a set of terms; and

FIG. 5B is a flow chart diagram illustrating one embodiment of a method for identifying the content representation value of a set of terms.

### DETAILED DESCRIPTION OF THE INVENTION

It will be readily understood that the components of embodiments of the present invention, as generally described and illustrated in the Figures herein, may be arranged and designed in a wide variety of different configurations. Thus, the following more detailed description of the embodiments of the apparatus, system, and method of the present invention, as presented in the Figures, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, function, or other construct. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, user interfaces, network transactions, database queries, database structures, hardware modules, hardware circuits, hardware chips, etc., to provide a thorough understanding of embodiments of the invention. One skilled in the relevant art will recognize, however, that the embodiments of the invention can be practiced without one or more of the specific details, or with other methods, components, materials, etc. In other instances, well-known structures, materials, or operations are not shown or described in detail to avoid obscuring aspects of the various embodiments.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

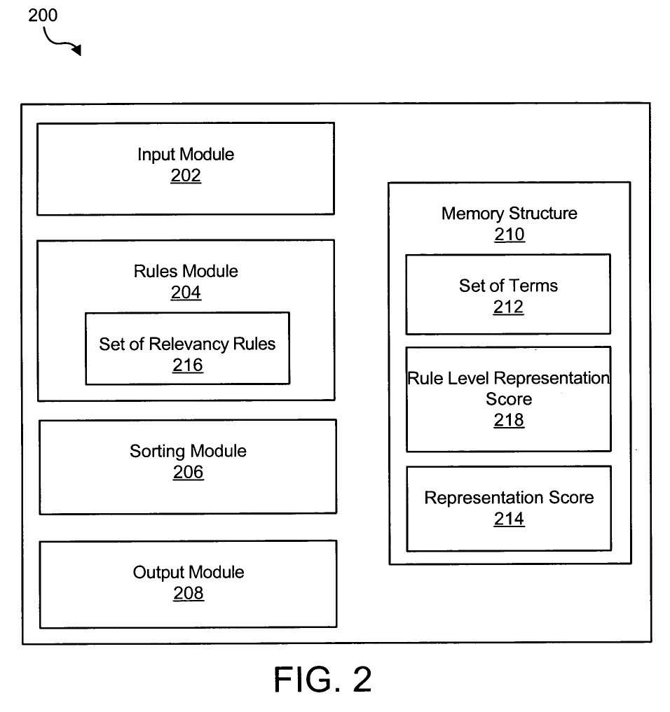

FIG. 2 illustrates an apparatus 200 for identifying the content representation value of a set of terms. The apparatus 200 includes an input module 202, a rules module 204, a sorting module 206, an output module 208, and a memory structure 210. The input module 202 parses a document 102 to identify a set of terms 212 used in the document 102. A user provides the document 102 by submitting the document 102 to the input module 202 via a web page, Graphical User Interface (GUI), script, file transfer, or the like.

As used herein, the word term refers to a word, phrase, tag, attribute, or other component found in the document 102. The input module 202 parses the document 102 to identify the unique terms used within the document 102. The document 102 may comprise a web page, electronic form, published document, file, or the like. Preferably, the input module 202 stores each term identified in the document 102 within a set of terms 212 in a memory structure 210 such as an array, linked list, object, database, or the like. The memory structure 210 is stored in physical memory comprised of integrated circuits, a magnetic hard drive, or other volatile or non-volatile storage device.

Optionally, the input module 202 may eliminate irrelevant terms from the set of terms 212. Irrelevant terms may comprise terms that do not convey the content, or subject matter, of the document 102. Common irrelevant terms may include “a,” “and,” “the,” “or,” “but,” other articles and common forms of common verbs such as “to be.” Preferably, the set of irrelevant terms is user-configurable so that terms may be added to the set or deleted from the set. Eliminating irrelevant terms may decrease the amount of memory required by the memory structure 210. Eliminating irrelevant terms may also decrease the amount of time the rules module 204 requires to process the document 102.

The rules module 204 determines a representation score 214 for each term identified by the input module 202. The rules module 204 applies a set of relevancy rules 216 to each term. The set of relevancy rules 216 comprises one or more rules. As described above, sample rules may include: testing to see if a term is present in the title of the document 102, the number of times the term is used in document 102, the location of the term in the document 102, whether or not the term is in the abstract of the document 102, and other rules known to those of skill in the art.

The rules module 204 applies a first rule in the set of relevancy rules 216 to each term to determine a rule level representation score 218 for the term. The rule level representation score 218 conveys the ability, according to the first relevancy rule, of a term to represent the content of the document 102 as a whole. The rules module 204 determines similar rule level representation scores 218 for each of the relevancy rules. The rules module 204 repeats this process for each of the terms in the set of terms 212.

Certain terms may represent the content of a document 102 more effectively than other terms. For example, a document 102 describing the proper way to display a flag may be well summarized by terms such as “flag,” “flagpole,” and “display”. Other terms such as “wind,” “unfold,” and “clean” may also be included in the document 102, but these terms are less effective at summarizing the document 102. Each relevancy rule is designed to assess the ability a term to represent the content of the document 102.

Once the rules module 204 applies each of the relevancy rules 216 to a term, the rules module 204 stores the resulting set of rule level representation scores 218 in the memory structure 210. The rules module 204 combines the rule level representation scores 218 for a term to get a single representation score 214.

The rules module 204 may combine the rule level representation scores 218 by applying a predetermined weight to each rule level representation score 218 and summing the resulting weighted scores to get a single representation score 214 for the term. Preferably, the weights used for each rule level representation score 218 are user-configurable. Of course, other methods readily recognizable to those of skill in the art may be used to combine the rule level representation scores 218 into a single representation score 214.

Preferably, the rules module 204 stores the resulting representation score 214 in the memory structure 210. The representation score 214 characterizes how well each term represents the content of the document 102.

Optionally, the rules module 204 may allow modification of the set of relevancy rules 216. Each rule in the set 216 may be enabled or disabled. Some relevancy rules 216 may not apply to particular documents 102. For example, a relevancy rule that searches for a term in an abstract of a document 102 may be undesirable for documents 102 without abstracts. A relevancy rule that searches for terms in the abstract may be disabled for documents 102 without abstracts to avoid this problem.

Additionally, the rules module 204 may allow new relevancy rules to be added to the set of relevancy rules 216. As new relevancy rules are developed, it may be desirable to add the new rules to the rules module 204. A weighting value may be specified when adding a new rule so that the rules module 204 will be able to incorporate the rule level representation score 218 resulting from the new rule into the representation score 214.

In one embodiment, the rules module 204 allows a user to define a plurality of sets of relevancy rules 216. Each set may contain one or more relevancy rules. The rules module 204 may use one rule set when evaluating a particular type of document 102. Similarly, the rules module 204 may use a second rule set to simulate the behavior of a particular search engine 106.

Optionally, the rules module 204 may interactively determine the representation score 214 for each term while a user edits an electronic version of the document 102. The electronic version of document may comprise a word processing format, markup language format, publishing format, or the like. As changes are made to the electronic version of the document 102, the rules module 204 may detect the changes and re-determine the representation score 214 for each term as the set of terms 212 grows.

In this embodiment, the apparatus does not require the input module 202 to parse the electronic version of the document 102. Instead, the rules module 204 detects changes directly. The ability to interactively determine a representation score 214 allows a user to make changes to the document 102 and quickly determine how the changes affect the representation score 214 for a term.

The sorting module 206 sorts the set of terms 212 based on each term's representation score 214. Typically, the sorting module 206 sorts the set of terms 212 by representation score 214 in descending order such that the term with the highest representation score 214 is listed first. Preferably, the sorting module 206 stores the sorted set of terms in the memory structure 210.

Optionally, the sorting module 206 may suggest changes to the document 102 that will improve the representation score 214 of a selected term. For example, a user may select a term by clicking on the term in a Graphical User Interface (GUI), typing the selected term in a text interface, or other similar method. The sorting module 206 may suggest actions such as including the selected term in the heading or title of the document 102, increasing the number of times the selected term is used in the document 102, or moving the selected term closer to the beginning of the document 102. The sorting module 206 may suggest actions based on the set of relevancy rules 216 used by the rules module 204. Suggesting improvements may decrease the time a user spends revising the document 102.

The output module 208 provides the sorted set of terms to a user. The output module 208 may access the sorted set of terms in the memory structure 210. The output module 208 provides the sorted set of terms to a user via a GUI, hard copy, file transfer, markup language, or the like. Typically, the output module 208 displays the term with the highest representation score at the top of the set of terms 212.

Optionally, in addition to providing an ordered list of terms, the output module 208 may also provide the representation score 214 for each term. The output module 208 accesses the memory structure 210 to get the representation score 214. The representation score 214 may be useful to a user in comparing various terms to each other. Additionally, the output module 208 may access the rule level representation scores 218 in the memory structure 210 and provide them to the user.

The rule level representation scores 218 may be useful in analyzing why a particular term has a high or low representation score 214. The output module 208 may summarize the rule corresponding to the rule level score so that the user may determine how to influence the score. For example, a rule that counts the number of times a term is used in the document 102 may be summarized in the output by the word “frequency.”

In one embodiment, the output module 208 may mark the representation score 214 or the rank for each term in an electronic version of the document 102. For example, the output module 208 may highlight each term using different colors to indicate the term's relative representation score 214. Terms with the highest scores may be highlighted yellow, terms with the next highest scores may be highlighted orange, and so on. Terms with low scores may have no highlighting.

Of course, the output module 208 may use other methods to highlight the representation score 214 such as using a bold font, italics font, underlining, superscripts, subscripts or the like. Alternatively, a GUI window may show an ordered list of terms, ordered by their representation score 214. The GUI window may comprise a script, plugin module, or the like that may be integrated with the electronic version of the document 102. Marking the representation score 214 in an electronic version of the document 102 enables a user to quickly see the representation score 214 or ranking for each term and more efficiently make edits to the document 102 to optimize the representation score 214 for a particular term.

Another embodiment of an apparatus for identifying the content representation value of a set of terms 212 may determine a synonym representation score for a set of synonyms for a selected term. Often search engines 106 locate documents 102 based on a set of synonyms of search terms 112 in addition to searching based on the search terms 112. Searching based on a set of synonyms may return useful documents that would not have been located if just the search terms 112 were considered.

In this embodiment of an apparatus, a rules module 204 may access one or more synonym lists to determine a set of synonyms for a term selected by a user. Preferably, the user may add a new synonym list to the set of synonym lists. The ability to modify the set of synonym lists is useful in optimizing a document 102 for different search engines 106. The rules module 204 may access a synonym list used by a first search engine 106 in optimizing a document 102 for the first search engine 106. Similarly, the rules module 204 may access a synonym list used by a second search engine 106 in optimizing a document 102 for the second search engine 106.

The user selects a term using a text interface, GUI, or the like. Alternatively, another application or apparatus may determine the seleteced term automatically. Preferably, the memory structure 210 stores a set of synonyms for the selected term. The rules module 204 then scores each synonym in substantially the same manner as described in relation to FIG. 2 above using a set of relevancy rules 216. The rules module 204 determines a set of synonym rule level representation scores for each synonym and preferably places the scores in the memory structure 210. The rules module 204 combines the synonym rule level representation scores to get a single synonym representation score for the synonym in substantially the same manner as described in relation to FIG. 2 above.

A sorting module 206 sorts the set of synonyms based on the synonym representation score for each synonym in substantially the same manner as described in relation to FIG. 2 above. An output module 208 provides the sorted set of synonyms to a user in substantially the same manner as described in relation to FIG. 2 above.

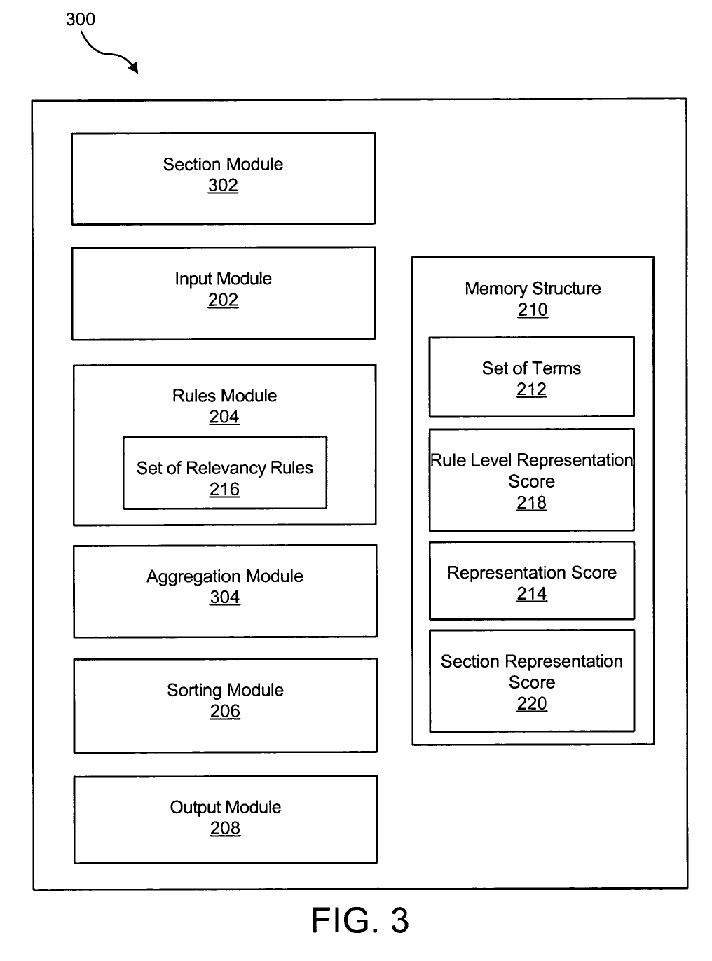

FIG. 3 illustrates another embodiment of an apparatus 300 for identifying the content representation value of a set of terms 212. The apparatus 300 includes a section module 302, an input module 202, a rules module 204, an aggregation module 304, a sorting module 206, an output module 208, and a memory structure 210. The section module 302 identifies sections of a document 102. The section module 302 parses the document 102 to determine the number of sections that comprise the document 102. An identifier defines each section in the document 102. The identifier may comprise a tag, a file, a keyword, or the like. The section module 302 may record information about each section, such as the section identifier, the section name, the terms in the section, and the like in the memory structure 210.

The input module 202 parses the document 102 and identifies a set of terms 212 used in the document 102 in substantially the same manner as described in relation to FIG. 2. In addition, the input module 202 records which sections each term is found in.

The rules module 204 determines a set of section representation scores for each term by applying a set of section relevancy rules. The rules module 204 uses the set of terms 212 identified by the input module 202 and the section information identified by the section module 302. Section relevancy rules are relevancy rules that may apply specifically to one section of a document 102. It may be desirable to identify the ability of a term to represent the content of a document 102 by using different relevancy rules for each section of the document 102. For example, a section relevancy rule may look for the position of a term in the title section of a document 102.

The rules module 204 determines a section representation score by applying one or more section relevancy rules to a section. If the rules module 204 applies more than one section relevancy rule to a single section, the rules module 204 combines the results of each of the section relevancy rules into a single section representation score 220. The rules module 204 may combine the results by applying a weighting to each of the results and summing the weighted results, or by other methods of aggregating multiple results into a single result. Preferably, the rules module 204 stores the section representation scores 220 in the memory structure 210.

The rules module 204 evaluates each of the section relevancy rules for each term. As a result, the rules module 204 produces a set of section representation scores 220 for each term. The aggregation module 304 obtains the section representation scores 220 for a single term from the memory structure 210 and combines the section representation scores 220 to determine an overall representation score 214. The aggregation module 304 may simply sum the section representation scores 220. Alternatively, the aggregation module 304 may emphasize the section representation scores 220 of certain sections, such as the title section, by assigning a weighting value to those sections. Preferably, the weighting values used by the aggregation module 304 are user-configurable.

The sorting module 206 sorts the set of terms 212 based on each term's overall representation score 214, as determined by the aggregation module 304. The sorting module 206 sorts in substantially the same manner as described in relation to FIG. 2. The output module 208 provides the sorted set of terms to a user in substantially the same manner as described in relation to FIG. 2. However, the output module 208 may additionally provide the set of section representation scores 220 for each term. A user may use the section representation scores 220 to optimize corresponding sections of the document 102.

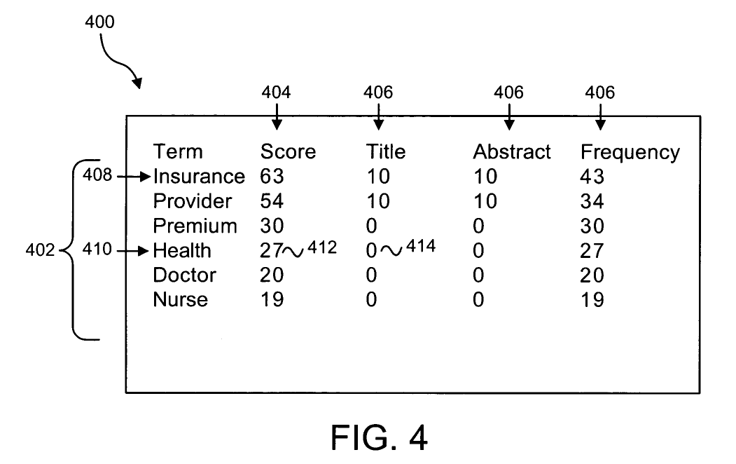

FIG. 4 illustrates a sample output 400 provided by the output module 208. The sample output 400 includes a list of sorted terms 402 sorted by their overall representation scores 404. Additionally, section representation scores 406 are included in the sample output 400. In the sample output 400 the aggregation module 304 (See FIG. 3) weighted each of the section scores 406 equally to obtain the overall representation score 404.

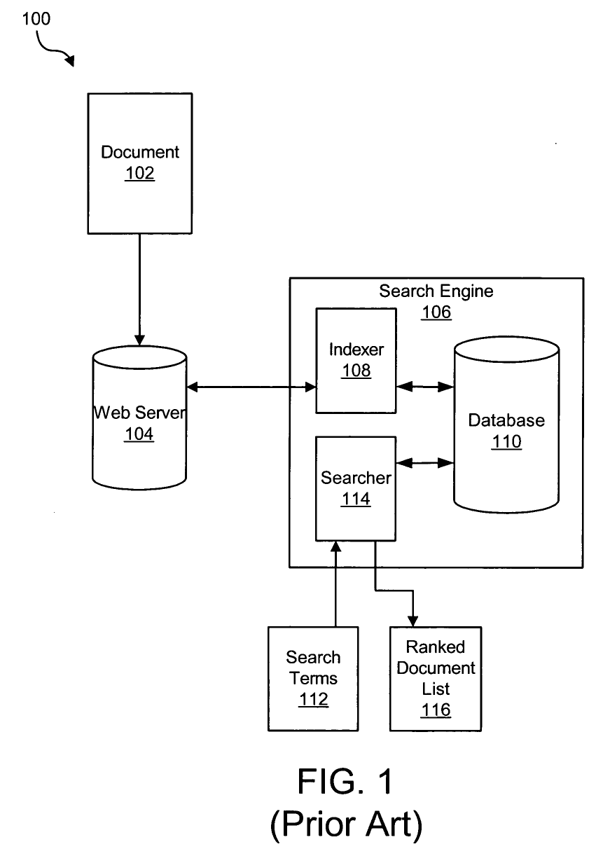

The user may optimize the document 102 using information provided in the sample output 400. For example, the user may intend the document 102 to be found by a search engine 106 when the search terms 112 (See FIG. 1) “health insurance” are submitted to the search engine 106. The user may notice in the sample output 400 that the term “insurance” 408 is highly ranked, but the term “health” 410 is ranked lower than desired. Since the user desires the highest score possible from a search engine 106 when the search terms 112 “health insurance” are submitted, the user may edit the document 102 to increase the ranking of the term “health” 410. The user may determine from the sample output 400 that one way of increasing the ranking of the term “health” 410 would be to include the term “health” 410 in the title of the document 102.

Including the term “health” 410 in the title of the document 102 will increase the overall representation score 412 for the term “health” 410 since the section representation score 414 for the title section of the document 102 for the term “health” 410 is zero. Similarly, including the term “health” 410 in the abstract will increase the overall representation score 412 for the term “health” 410. The user may make several edits to the document 102 that increase the overall representation score 412 for the term “health” 410 and then submit the document 102 to the apparatus 300 (See FIG. 3) again for evaluation. In this manner, the user may iteratively edit the document 102 until the set of terms 212 have a desired ranking. The apparatus 300 provides an efficient tool for iteratively editing the document 102 by providing specific feedback regarding the representation value for each of the set of terms 212. The user may perform the iterative editing process without a lengthy process for publishing the document 102 on a web server 104 (See FIG. 1) Once editing is complete the document 102 may be published on the web server 104, making the document 102 accessible to a search engine 106.

Another embodiment of the invention may determine and provide a ranked set of synonyms for a selected term based on a set of section relevancy rules. The apparatus ranks the synonyms using an overall synonym representation score that the apparatus derives from a set of synonym section representation scores in substantially the same manner as describe above in relation to FIG. 3. The apparatus determines the set of synonyms in substantially the same manner as described in relation to FIG. 2.

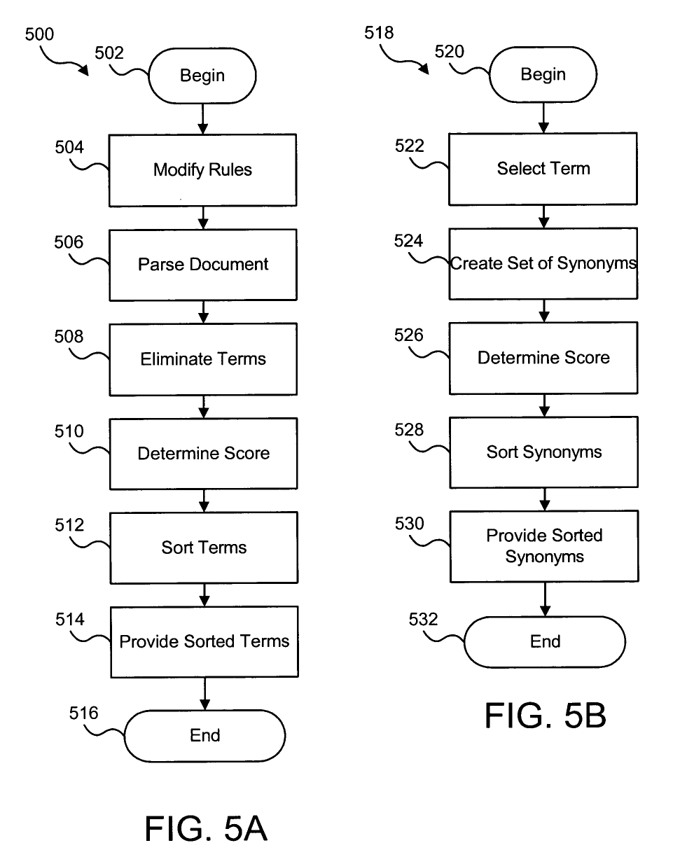

FIG. 5A illustrates one embodiment of a method 500 for identifying the content representation value of a set of terms 212 for a document 102. The method may begin 502 when a user optionally modifies 504 the set of relevancy rules 216 to be used in determining the representation score 214 for each term. Modifying the rules may be desirable as described in relation to FIG. 2 above. Next, an input module 202 parses 506 the document 102 to identify the set of terms 212 used in the document 102.

Preferably, the input module 202 eliminates 508 irrelevant terms from the set of terms 212 before storing the set of terms 212 in a memory structure 210. A rules module 204 obtains the set of terms 212 from the memory structure 210 and determines 510 a representation score 214 by applying a set of relevancy rules 216 to each term. The representation score 214 for each term may be stored in the memory structure 210.

A sorting module 206 sorts 512 the set of terms 212 based on the representation score 214 for each term obtained from the rules module 204. An output module 208 provides 514 the sorted set of terms 212 to a user and the method ends 516. Preferably, the output module 208 provides the representation score 214 and rule level representation scores 218 for each term.

Optionally, the user selects a term and the output module 208 may suggest changes to the document 102 that will improve the representation score 214 of the selected term. Preferably, the output module 208 marks the representation score 214 for each term in an electronic version of the document 102 so that the user may interactively determine the representation score 214 for each term while editing the electronic version of the document.

The user may iteratively repeat the method 500 and edit the document 102 to improve the representation score 214 of a particular term used in the document 102. The user may edit the term position, term placement, frequency of the term, or other aspects of the term to improve the representation score 214. The user then applies the method 500 to the edited document 102 to obtain an updated term relevancy ranking. The user repeats the steps of editing and performing the method 500 until the desired term relevancy ranking is realized. In this manner, the user may ensure that the terms the user believes closely represent the content of the document 102 are also the highest ranked terms as determined by the method 500.

Once the user optimizes the document 102 by the iterative process described above, the user may place the document 102 on a web server 104. A search engine 106 may return the optimized document 102 when someone searching for documents using search terms 112 that are substantially the same as the terms that the user optimized in the document 102.

FIG. 5B illustrates one embodiment of a method 518 for identifying the content representation value of a set of synonyms for a selected term. The method begins 520 when a user selects 522 a term. A rules module 204 creates 524 a set of synonyms for the selected term based on a synonym list. The rules module 204 determines 526 a synonym representation score by applying a set of relevancy rules 216 to each synonym. The rules module 204 may store the synonym representation score for each synonym in a memory structure 210.

A sorting module 206 sorts 528 the set of synonyms based on the synonym representation score for each synonym obtained from the rules module 204. An output module 208 provides 530 the sorted set of synonyms to a user and the method ends 532. Preferably, the output module 208 provides the synonym representation score 214 and rule level synonym representation scores 218 for each synonym.

Optionally, the user selects a synonym and the output module 208 may suggest changes to the document 102 that will improve the synonym representation score 214 of the selected synonym. Preferably, the output module 208 marks the synonym representation score for each synonym in an electronic version of the document 102 so that the user may interactively determine the synonym representation score 214 for each synonym while editing the electronic version of the document 102.

The embodiments of the present invention may be embodied in other specific forms without departing from its spirit or essential characteristics. The described embodiments are to be considered in all respects only as illustrative and not restrictive. The scope of different embodiments of the invention is, therefore, indicated by the appended claims rather than by the foregoing description. All changes which come within the meaning and range of equivalency of the claims are to be embraced within their scope.

What is claimed is:

1. An apparatus for identifying the content representation value of a set of terms, the apparatus comprising:
an input module configured to parse a document to identify a set of terms used in the document;
a rules module configured to determine a representation score by applying a set of relevancy rules to each term;
a sorting module configured to sort the set of terms based on the representation score for each term; and
an output module configured to provide the sorted set of terms.

2. The apparatus of claim 1, wherein the input module is further configured to eliminate irrelevant terms from the set of terms.

3. The apparatus of claim 1, wherein the output module is further configured to provide the representation score for each term.

4. The apparatus of claim 1, wherein the output module is further configured to provide a rule level representation score for each relevancy rule for each term.

5. The apparatus of claim 1, wherein the rules module is further configured to modify the set of relevancy rules to be used in determining the representation score for each term.

6. The apparatus of claim 1, wherein the sorting module is further configured to suggest changes to the document that will improve the representation score of a selected term.

7. The apparatus of claim 1, wherein:
the rules module is further configured to determine a synonym representation score by applying the set of relevancy rules to each synonym within a set of synonyms for a selected term;
the sorting module is further configured to sort the set of synonyms based on the synonym representation score for each synonym; and
the output module is further configured to provide the sorted set of synonyms.

8. The apparatus of claim 1, wherein the output module is further configured to mark the representation score for each term in an electronic version of the document.

9. The apparatus of claim 8, wherein the rules module is further configured to interactively determine the representation score for each term while editing the electronic version of document.

10. A apparatus for identifying the content representation value of a set of terms, the apparatus comprising:
a section module configured to identify sections of a document;
an input module configured to parse the document to identify a set of terms used in the document;
a rules module configured to determine a set of section representation scores for each term by applying a set of section relevancy rules;
an aggregation module configured to weight the set of section representation scores for each term to determine an overall representation score;
a sorting module configured to sort the set of terms based on the overall representation score for each term; and
an output module configured to provide the sorted set of terms.

11. The apparatus of claim 10, wherein the output module is further configured to provide the set of section representation scores for each term.

12. A signal bearing medium tangibly embodying a program of machine-readable instructions executable by a digital processing apparatus to perform operations to identify the content representation value of a set of terms, the operations comprising:
an operation to parse a document to identify a set of terms used in the document;
an operation to determine a representation score by applying a set of relevancy rules to each term;
an operation to sort the set of terms based on the representation score for each term; and
an operation to provide the sorted set of terms.

13. The signal bearing medium of claim 12, further comprising an operation to eliminate irrelevant terms from the set of terms.

14. The signal bearing medium of claim 12, further comprising an operation to provide the representation score for each term.

15. The signal bearing medium of claim 12, further comprising an operation to provide a rule level representation score for each relevancy rule for each term.

16. The signal bearing medium of claim 12, further comprising an operation to modify the set of relevancy rules to be used in determining the representation score for each term.

17. The signal bearing medium of claim 12, further comprising an operation to suggest changes to the document that will improve the representation score of a selected term.

18. The signal bearing medium of claim 12, further comprising:
an operation to determine a synonym representation score by applying the set of relevancy rules to each synonym with a set of synonyms for a selected term;
an operation to sort the set of synonyms based on the synonym representation score for each synonym; and
an operation to provide the sorted set of synonyms.

19. The signal bearing medium of claim 12, further comprising an operation to mark the representation score for each term in an electronic version of the document.

20. The signal bearing medium of claim 19, further comprising an operation to interactively determine the representation score for each term while editing the electronic version of the document.
